(19) United States
(12) Patent Application Publication
(10) Pub. No.: US 2011/0193263 A1
(43) Pub. Date: Aug. 11, 2011

(54) NANO IMPRINT APPARATUS AND METHOD OF FABRICATING SEMICONDUCTOR DEVICE USING THE SAME

(75) Inventors: Jeong-hoon LEE, Yongin-si (KR); Chang-min PARK, Hwaseong-si (KR); Jong-chan SHIN, Seongnam-si (KR); Jeong-ho YEO, Suwon-si (KR)

(73) Assignee: Samsung Electronics Co., Ltd., Suwon-si (KR)

(21) Appl. No.: 12/986,705

(22) Filed: Jan. 7, 2011

(30) Foreign Application Priority Data
Feb. 9, 2010 (KR) 1020100012022

(51) Int. Cl. B29C 59/02; B82Y 40/00

(52) U.S. Cl. 264/293; 425/385; 977/932

(57) ABSTRACT

A nano imprint apparatus comprising: a nano imprint template; and a deformation correction unit arranged on the nano imprint template to correct deformation of the nano imprint template.

### CROSS-REFERENCE TO RELATED APPLICATIONS

This application claims the benefit of Korean Patent Application No. 10-2010-0012022, filed on Feb. 9, 2010, in the Korean Intellectual Property Office, the disclosure of which is incorporated herein in its entirety by reference.

### BACKGROUND

The present inventive concept relates to a nano imprint apparatus and a method of fabricating a semiconductor device using the same, and more particularly, to a nano imprint apparatus that corrects deformation of a nano imprint template, and a method of fabricating a semiconductor device using the same.

Research is actively being conducted on next generation nano imprint lithography processes. However, practical solutions for techniques to correct deformation of a nano imprint template have not been suggested.

### SUMMARY

The inventive concept provides a nano imprint apparatus that corrects deformation of a nano imprint template.

The inventive concept provides a method of fabricating a semiconductor device using the nano imprint apparatus that corrects deformation of a nano imprint template.

According to an aspect of the inventive concept, there is provided a nano imprint apparatus comprising a nano imprint template and a deformation correction unit. The deformation correction unit is arranged on the nano imprint template to correct deformation of the nano imprint template. The deformation correction unit may be a transparent deformation correction unit formed on an upper portion of the nano imprint template.

The transparent deformation correction unit may comprise a transparent electrode portion that comprises indium tin oxide (ITO).

The transparent electrode portion may comprise a plurality of transparent electrodes that are arranged in an array format. Each of the plurality of transparent electrodes independently may receive a voltage, and the applied voltage may be controlled to change the volume of the nano imprint template.

According to another aspect of the inventive concept, there is provided a nano imprint apparatus comprising a nano imprint template and a deformation correction unit. The deformation correction unit is arranged on the nano imprint template to correct deformation of the nano imprint template. The deformation correction unit may be formed at a side portion of the nano imprint template.

The deformation correction unit may comprise a material whose volume is changeable when a voltage is applied. The material whose volume is changeable may comprise a piezo material.

According to another aspect of the inventive concept, there is provided a method comprising forming a hard mask layer on a substrate, loading a nano imprint apparatus on the hard mask layer, the nano imprint apparatus comprising a nano imprint template and a deformation correction unit arranged on the nano imprint template to correct deformation of the nano imprint template, changing the volume of the nano imprint apparatus by using the deformation correction unit, pressing the nano imprint template against the hard mask layer, irradiating light onto the hard mask layer by passing the light through the nano imprint template, and forming a hard mask layer pattern by removing the nano imprint template from the hard mask layer and removing part of the hard mask layer. The deformation correction unit may comprise a transparent deformation correction unit that is formed on an upper portion of the nano imprint template.

The deformation correction unit may comprise a transparent electrode portion that comprises a plurality of transparent electrodes arranged in an array format and comprising indium tin oxide (ITO) and, in the changing of the volume of the nano imprint apparatus, a voltage may be independently applied to each of the plurality of transparent electrodes

According to another aspect of the inventive concept, there is provided a method comprising forming a hard mask layer on a substrate, loading a nano imprint apparatus on the hard mask layer, the nano imprint apparatus comprising a nano imprint template and a deformation correction unit arranged on the nano imprint template to correct deformation of the nano imprint template, changing the volume of the nano imprint apparatus by using the deformation correction unit, pressing the nano imprint template against the hard mask layer, irradiating light onto the hard mask layer by passing the light through the nano imprint template, and forming a hard mask layer pattern by removing the nano imprint template from the hard mask layer and removing part of the hard mask layer. The deformation correction unit may be formed at a side portion of the nano imprint apparatus.

### BRIEF DESCRIPTION OF THE DRAWINGS

Exemplary embodiments of the inventive concept will be more clearly understood from the following detailed description taken in conjunction with the accompanying drawings in which:

FIGS. 1-3 are cross-sectional views for explaining a method of fabricating a semiconductor device by using a nano imprint apparatus according to an exemplary embodiment of the present inventive concept;

FIG. 4 is a plan view illustrating an upper surface of a deformation correction unit attached to the nano imprint template of FIGS. 1-3;

FIGS. 5-7 are cross-sectional views for explaining a method of fabricating a semiconductor device by using a nano imprint apparatus according to another exemplary embodiment of the present inventive concept;

FIG. 8 is a plan view illustrating a deformation correction unit formed at a side portion of the nano imprint template of FIG. 5-7, according to an exemplary embodiment of the present inventive concept;

FIG. 9 is a plan view illustrating a deformation correction unit formed at a side portion of the nano imprint template of FIG. 5-7, according to another exemplary embodiment of the present inventive concept;

FIG. 10 is a cross-sectional view taken along a line A-a′ of FIG. 9; and

FIG. 11 illustrates a crystal arrangement of a piezo material constituting the deformation correction unit of FIG. 8-9.

### DETAILED DESCRIPTION OF THE EMBODIMENTS

Reference will now be made in detail to exemplary embodiments, examples of which are illustrated in the accompanying drawings. However, exemplary embodiments are not limited to the embodiments illustrated hereinafter, and the embodiments herein are rather introduced to provide easy and complete understanding of the scope and spirit of exemplary embodiments. In the drawings, the thicknesses of layers and regions are exaggerated for clarity.

It will be understood that when an element, such as a layer, a region, or a substrate, is referred to as being “on,” “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of exemplary embodiments.

Spatially relative terms, such as “above,” “upper,” “beneath,” “below,” “lower,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “above” may encompass both an orientation of above and below. The device may be otherwise oriented (rotated 90 degrees or at other orientations) and the spatially relative descriptors used herein interpreted accordingly.

In the present specification, the term “layer” is used to denote a part of a structure generated by deposited objects. Thus, the term “layer” may not be interpreted to have a meaning that is limited by the thicknesses of the objects.

### First Exemplary Embodiment

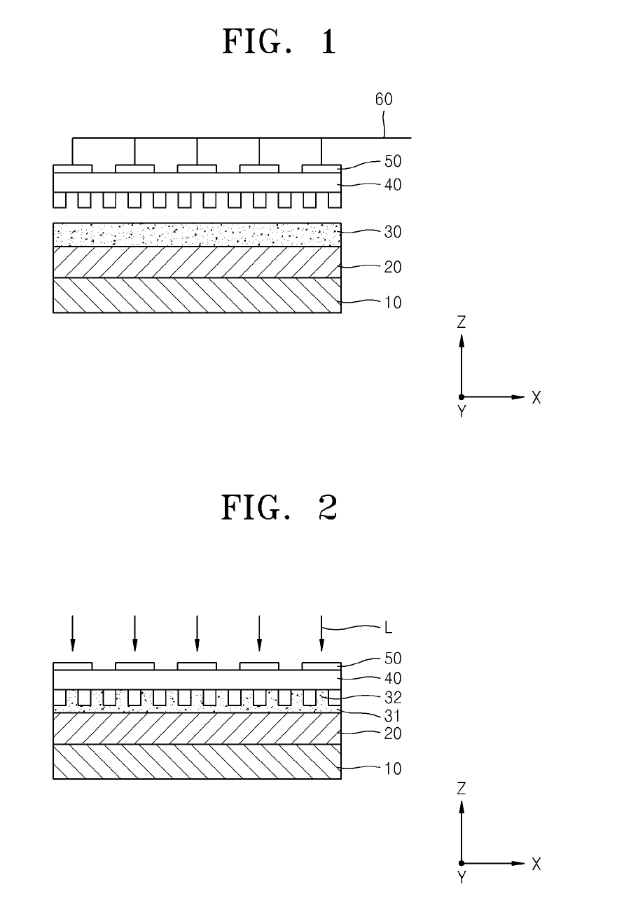

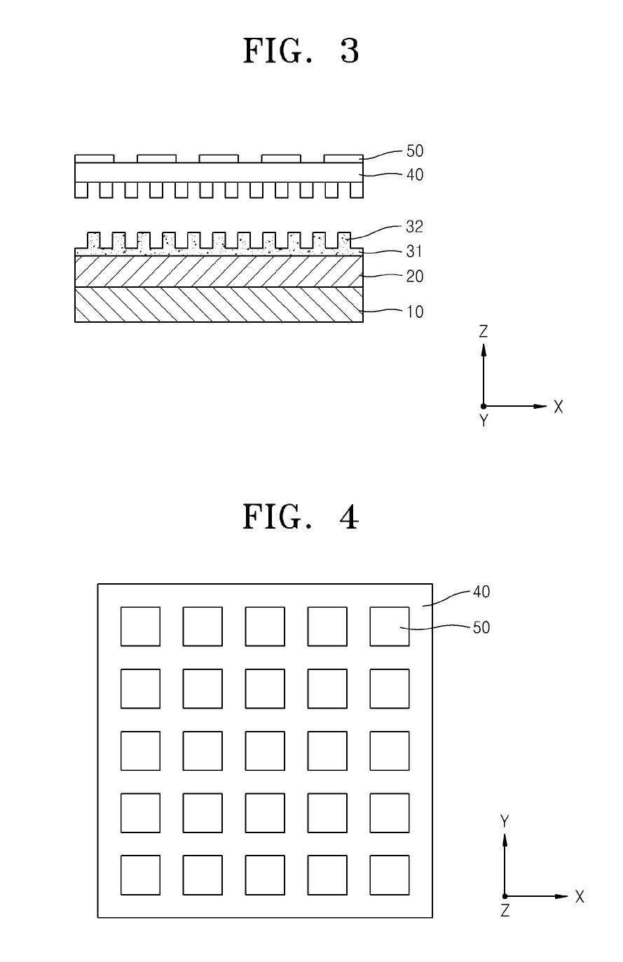

FIGS. 1-3 are cross-sectional views for explaining a method of fabricating a semiconductor device by using a nano imprint apparatus according to an exemplary embodiment of the present inventive concept. Referring to FIG. 1, the nano imprint apparatus according to the present exemplary embodiment includes a nano imprint template 40 and a deformation correction unit 50. The deformation correction unit 50 receives power via a power supply line 60. The deformation correction unit 50 for correcting deformation of the nano imprint template 40 may be formed on an upper portion of the nano imprint template 40 by using an optically transparent material. The transparent deformation correction unit 50 may comprise a transparent electrode portion including indium tin oxide (ITO).

FIG. 4 is a plan view illustrating an upper surface of the deformation correction unit 50 attached to the nano imprint template 40. Referring to FIG. 4, the deformation correction unit 50 is attached on the nano imprint template 40 and comprises a transparent electrode portion in which a plurality of transparent electrodes are arranged in an array format. In this case, the transparent electrodes may be configured to independently receive power.

Referring back to FIG. 1, a hard mask layer 30 is formed on a substrate 20. The substrate 20 may be placed on a chuck 10. The hard mask layer 30 may include, for example, a polymer. The nano imprint apparatus including the nano imprint template 40 and the deformation correction unit 50 formed on the nano imprint template 40 is loaded on the hard mask layer 30.

The deformation correction unit 50 makes the nano imprint template 40 expand or contract. When the deformation correction unit 50 is configured to comprise a transparent electrode portion including ITO, it is possible to control the expansion and contraction of the nano imprint template 40 through electrical and/or thermal adjustment by applying a voltage to the transparent electrode portion.

Referring to FIG. 2, the nano imprint template 40 is pressed against the hard mask layer 30. A first hard mask layer pattern 32 located between protruding portions of the nano imprint template 40 is formed when the hard mask layer 30 is pressed by the nano imprint template 40, and a remaining portion of the hard mask layer 30 is a second hard mask layer pattern 31. After the pressing process, light L is irradiated onto the hard mask layer 30 by passing through the deformation correction unit 50 and the nano imprint template 40. In particular, since the deformation correction unit 50 is transparent, the arrangement of the deformation correction unit 50 on the nano imprint template 40 is no hindrance to the irradiation of the light L.

After the light L is irradiated onto the hard mask layer 30, the nano imprint template 40 is removed from the hard mask layer 30, the second hard mask layer pattern 31 is removed, and thus a hard mask layer pattern in which only the first hard mask layer pattern 32 remains is formed.

### Second Exemplary Embodiment

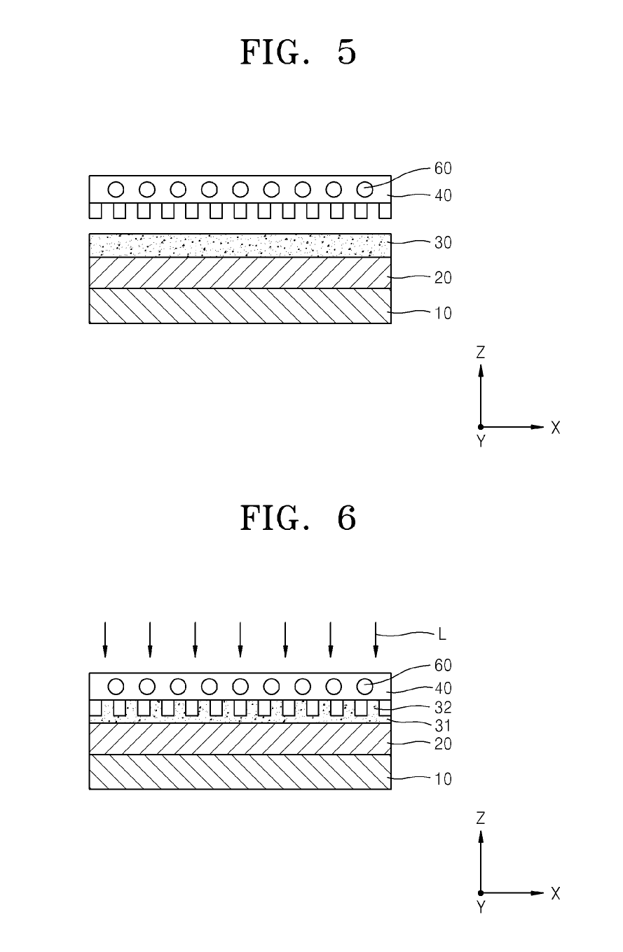

FIGS. 5-7 are cross-sectional views for explaining a method of fabricating a semiconductor device by using a nano imprint apparatus according to another exemplary embodiment of the present inventive concept. Referring to FIG. 5, the nano imprint apparatus according to the present exemplary embodiment includes the nano imprint template 40 and a deformation correction unit 60. The deformation correction unit 60 for correcting deformation of the nano imprint template 40 may be formed at a side portion of the nano imprint template 40.

FIG. 8 is a plan view illustrating the deformation correction unit 60 formed at the side portion of the nano imprint template 40, according to an exemplary embodiment of the present inventive concept. Referring to FIG. 8, the deformation correction unit 60 is attached directly to the side portion of the nano imprint template 40.

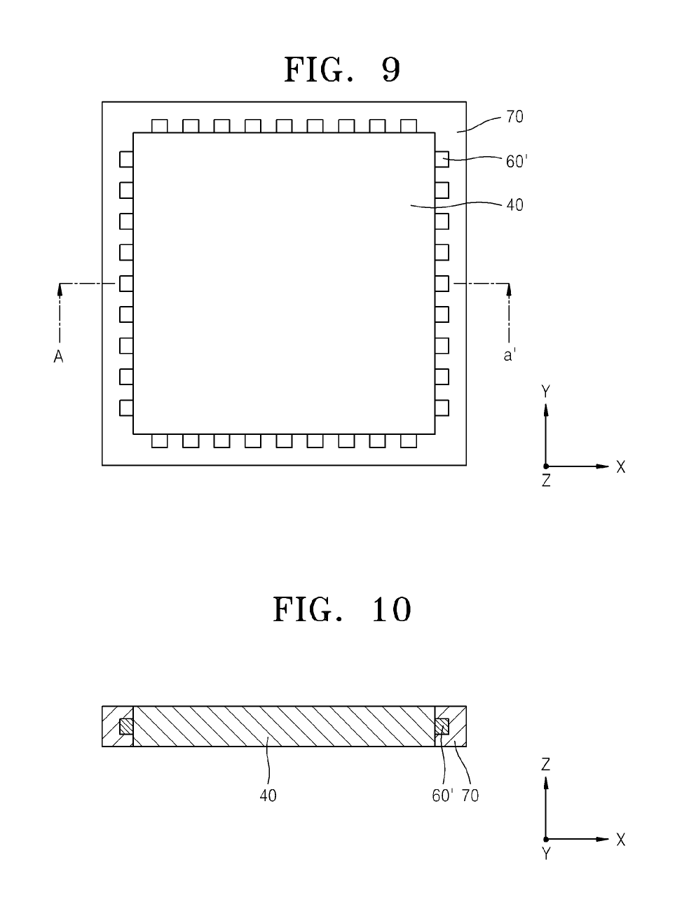

FIG. 9 is a plan view illustrating a deformation correction unit 60′ formed at the side portion of the nano imprint template 40, according to another exemplary embodiment of the present inventive concept. FIG. 10 is a cross-sectional view taken along a line A-a′ of FIG. 9. Referring to FIGS. 9 and 10, the deformation correction unit 60′ fixed at a frame 70 is arranged at the side portion of the nano imprint template 40.

Referring back to FIG. 5, the deformation correction unit 60 may be configured to include a material that may expand or contract when a voltage is applied, preferably, a piezo material.

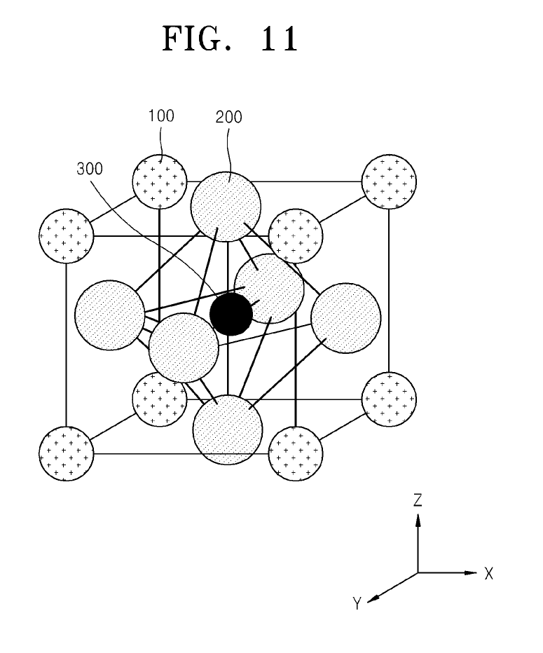

FIG. 11 illustrates crystal arrangement of a piezo material constituting the deformation correction unit 60. Referring to FIG. 11, a first particle 100 and a second particle 200 are arranged to configure a face centered cubic (FCC). The second particle 200 is located at the center of each surface of a cubic. The first particle 100 is located at each corner of the cubic. A third particle 300 is located at the center of the cubic. For example, the first particle 100 may be Pb²⁺ or La³⁺, the second particle 200 may be O²⁻, and the third particle 300 may be Zr⁴⁺, Ti⁴⁺, Mg²⁺, or Nb³⁺. The piezo material is a material whose mechanical properties are changed when an external voltage is applied. That is, in terms of a crystal structure, as the second particle 200 is moved along a directional axis of an electric field that is applied, the volume of a material expands or contracts.

Referring back to FIG. 5, the hard mask layer 30 is formed on the substrate 20. The substrate 20 may be placed on the chuck 10. The hard mask layer 30 may include, for example, a polymer. The nano imprint apparatus including the nano imprint template 60 and the deformation correction unit 50 formed at the side portion of the nano imprint template 40 is loaded on the hard mask layer 30.

The deformation correction unit 60 makes the nano imprint template 40 expand or contract. When the deformation correction unit 60 is configured to include a plurality of piezo materials, deformation of the nano imprint template 40 may be corrected at various positions through an expansion and contraction phenomenon by independently applying a voltage to each of the piezo materials.

Referring to FIG. 6, the nano imprint template 40 is pressed against the hard mask layer 30. The first hard mask layer pattern 32 located between the protruding portions of the nano imprint template 40 is formed when the hard mask layer 30 is pressed by the nano imprint template 40, and a remaining portion of the hard mask layer 30 is the second hard mask layer pattern 31. After the pressing process, light L is irradiated onto the hard mask layer 30 by passing through the nano imprint template 40. In particular, since the deformation correction unit 60 is formed at the side portion of the nano imprint template 40, even when the deformation correction unit 60 is not transparent, no hindrance occurs in the irradiation of the light L.

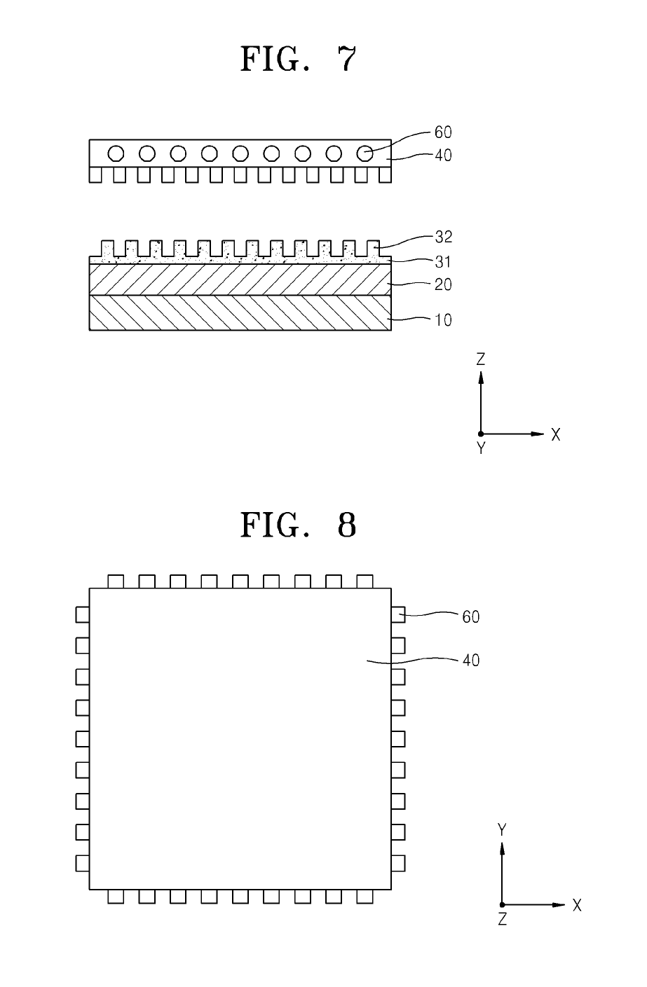

Referring to FIG. 7, after the light L is irradiated onto the hard mask layer 30, the nano imprint template 40 is removed form the hard mask layer 30. Then, the second hard mask layer pattern 31 is removed, and thus a hard mask layer pattern in which only the first hard mask layer pattern 32 remains is formed.

As described above, according to the nano imprint apparatus according to the present inventive concept, deformation of a nano imprint template may be easily corrected.

Also, according to the method of fabricating a semiconductor device, a semiconductor device may be fabricated by easily correcting deformation of a nano imprint template.

While the inventive concept has been particularly shown and described with reference to exemplary embodiments thereof, it will be understood that various changes in form and details may be made therein without departing from the spirit and scope of the following claims.

What is claimed is:

1. A nano imprint apparatus comprising:
a nano imprint template; and
a deformation correction unit arranged on the nano imprint template to correct deformation of the nano imprint template.

2. The nano imprint apparatus of claim 1, wherein the deformation correction unit is a transparent deformation correction unit formed on an upper portion of the nano imprint template.

3. The nano imprint apparatus of claim 2, wherein the transparent deformation correction unit comprises a transparent electrode portion that comprises indium tin oxide (ITO).

4. The nano imprint apparatus of claim 3, wherein the transparent electrode portion comprises a plurality of transparent electrodes that are arranged in an array format.

5. The nano imprint apparatus of claim 4, wherein each of the plurality of transparent electrodes independently receives a voltage, and the applied voltage is controlled to change the volume of the nano imprint template.

6. The nano imprint apparatus of claim 1, wherein the deformation correction unit is formed at a side portion of the nano imprint template.

7. The nano imprint apparatus of claim 6, wherein the deformation correction unit comprises a material whose volume is changeable when a voltage is applied.

8. The nano imprint apparatus of claim 7, wherein the material whose volume is changeable comprises a piezo material.

9. A method of fabricating a semiconductor device, the method comprising:
forming a hard mask layer on a substrate;
loading a nano imprint apparatus on the hard mask layer, the nano imprint apparatus comprising a nano imprint template and a deformation correction unit arranged on the nano imprint template to correct deformation of the nano imprint template;
changing the volume of the nano imprint apparatus by using the deformation correction unit;
pressing the nano imprint template against the hard mask layer;
irradiating light onto the hard mask layer by passing the light through the nano imprint template; and
farming a hard mask layer pattern by removing the nano imprint template from the hard mask layer and removing part of the hard mask layer.

10. The method of claim 9, wherein the deformation correction unit comprises a transparent deformation correction unit that is formed on an upper portion of the nano imprint template.

11. The method of claim 10, wherein the deformation correction unit comprises a transparent electrode portion that comprises a plurality of transparent electrodes arranged in an array format and comprising indium tin oxide (ITO) and, in the changing of the volume of the nano imprint apparatus, a voltage is independently applied to each of the plurality of transparent electrodes.

12. The method of claim 10, wherein, in the irradiating of light onto the hard mask layer, light is irradiated onto the hard mask layer by passing through the deformation correction unit and the nano imprint apparatus.

13. The method of claim 9, wherein the deformation correction unit is formed at a side portion of the nano imprint apparatus.

14. The method of claim 13, wherein the deformation correction unit comprises a material whose volume is changeable when a voltage is applied.

15. The method of claim 14, wherein the material whose volume is changeable comprises a piezo material.
